(19) United States
(12) Patent Application Publication
(10) Pub. No.: US 2002/0048679 A1
(43) Pub. Date: Apr. 25, 2002

(54) HYDROPHOBICIZATION PROCESS FOR POLYMERIC SUBSTRATES

(76) Inventors: GUNTHER LOHMER, MUELHEIM (DE); PETER OTTERSBACH, WINDECK (DE)

Correspondence Address: OBLON SPIVAK MCCLELLAND MAIER &, NEUSTADT PC, FOURTH FLOOR, 1755 JEFFERSON DAVIS HIGHWAY, ARLINGTON, VA, 22202

(21) Appl. No.: 09/480,635

(22) Filed: Jan. 10, 2000

(30) Foreign Application Priority Data
Jan. 8, 1999 (DE) 19900494.3

(51) Int. Cl. B32B 9/04

(52) U.S. Cl. 428/447

(57) ABSTRACT

Long-term-hydrophobic coatings on polymeric substrates are prepared by reacting the polymeric substrates initially with a silane derivative of formula I:

[Y(R¹Z)ₘR²]ₙSiR³ₚX₄₋ₙ₋ₚ (I)

where p=0 to 2, n=0 to (3−p), and m=0 to 5; R¹, R², R³=a C₁-C₁₂-alkyl radical, a C₂-C₁₂-alkylene radical, a phenyl radical or a phenylalkyl radical, wherein R² and R³ in each case are identical or nonidentical to R¹;

Y═HS—, H₂N—, HR¹N—, R¹₂N—, —Cl, —Br, —I, —CN, R¹S—,

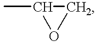

—SO₂Cl, OCN—, —CO₂R¹ or —SCN,

Z═—S—, —O—, R¹N— or —HN—, X═F—, Cl—, Br—, R⁴O—, HO—, H— or —NR₂¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby imparting structure to the surfaces of the polymeric substrates, and then reacting the treated surfaces with a hydrophobic compound.

### BACKGROUND OF THE INVENTION

1. Field of the Invention

The present invention relates to a process for providing a long-term hydrophobic coatings on polymeric substrates.

2. Description of the Background

Surfaces from which water runs off easily have to be either very hydrophilic or hydrophobic. Hydrophilic surfaces have low contact angles with water, and this brings about rapid distribution of the water on the surface and finally rapid run-off of the resultant film of water from the surface.

In contrast, hydrophobic surfaces form droplets through large contact angles with water. These droplets can roll off rapidly from inclined surfaces.

Articles with surfaces which are difficult to wet have a number of interesting and commercially important features. For example, they are easy to clean, and deposits find it difficult to adhere. These properties are particularly relevant to articles which are transparent and esthetically attractive.

The use of hydrophobic materials such as perfluorinated polymers for producing hydrophobic surfaces is known. These surfaces can be improved by giving them a structure in the μm to nm region.

U.S. Pat. No. 5,599,489 discloses a process for structuring surfaces. The method disclosed can provide a particularly water-repellent surface via bombardment with particles of an appropriate size, followed by perfluorination.

Another process is described by H. Saito et al. in Surface Coating International 4, 1997, pp. 168 ff. Here, particles of fluoropolymers are built-up on metal surfaces, and the result observed was markedly reduced water-wetability of the surfaces created in the manner described and considerably reduced susceptibility to icing.

U.S. Pat. No. 3,354,022 and WO 96/04123 describe other processes for lowering the wettability of articles via topological changes to their surfaces. Here, artificial elevations and/or depressions of height from about 5-1000 μm and from about 5-500 μm apart are applied to materials which are hydrophobic or are hydrophobicized after structuring. Surfaces of this type lead to rapid droplet formation, and as they roll off the droplets pick up dirt particles and thus clean the surface.

Surfaces of this type also have high contact angles with water, but are completely wetted by liquids such as oil. When wetting has taken place, this also eliminates the effect, resulting from the structure, of the high contact angle with water. Applications of materials of this type are, therefore, limited to sectors where there are no liquids which form oil films, e.g. in road traffic applications.

The structuring of surfaces in the dimensions mentioned, which are usually microstructures, is a complicated and, therefore, expensive process. There are particular problems with injection molding, since the microstructured female molds do not allow easy release of the injection molding and the release procedure can damage the microstructure of the molding. A need, therefore, continues to exist for hydrophobic polymer coatings on substrates of improved long-tern stability.

### SUMMARY OF THE INVENTION

Accordingly, one object of the present invention is to provide a process for the long-term-hydrophobic coating of polymers which is easy to conduct and gives coatings which can be cleaned simply by rinsing, e.g. with water.

Briefly, this object and other objects of the present invention as hereinafter will become more readily apparent can be attained in a process for producing hydrophobic coatings on polymeric substrates by initially reacting the polymeric substrate with a silane derivative of formula I:

[Y(R¹Z)ₘR²]ₙSiR³ₚX₄₋ₙ₋ₚ (I)

where p=0 to 2, n=0 to (3−p), and m=from 0 to 5, R¹, R², R³=a C₁-C₁₂-alkyl radical, a C₂-C₁₂-alkylene radical, a phenyl radical or a phenylalkyl radical, where R² and R³ in each case are identical or nonidentical to R¹,

Y═HS—, H₂N—, HR¹N—, R¹₂N—, —Cl, —Br, —CN, R¹S—,

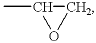

—SO₂Cl, OCN—, —CO₂R¹ or —SCN,

Z═—S—, —O—, R¹N— or —HN—,

X═F—, Cl—, Br—, R⁴O—, HO—, H— or —NR₂¹, where R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby structuring the surfaces of the polymeric substrates, and then with a hydrophobic compound.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1-3 are SEM photographs of polysiloxane film substrates coated with solutions containing different concentrations of N-(2-aminoethyl)-3-aminopropyltrimethoxysilane surface coating agent;

FIG. 4 is an SEM photograph of a polysiloxane film substrate coated with a solution of a specific concentration of 3-aminopropyltrimethoxysilane surface coating agent; and

FIG. 5 is an SEM photograph of a polysiloxane film substrate coated with a solution of a specific concentration of 3-trimethoxysilylpropyldiethylenetriamine surface coating agent

### DETAILED DESCRIPTION OF THE PREFERRED EMBODIMENTS

Surprisingly, it has been found that polymeric substrates can be provided with a hydrophobic coating in a simple manner by reaction in succession with functionalized silane derivatives and with a hydrophobic compound.

The following silane derivatives are particularly suitable for conducting the process of the invention.

H₂NC₃H₆Si(OCH₃)₃,

H₂NC₂H₄NHC₃H₆Si(OCH₃)₃,

HSC₃H₆Si(OCH₃)₃,

H₂NC₂H₄NHC₂H₄NHC₃H₆Si(OCH₃)₃,

(CH₃)₂NC₃H₆Si(OCH₃)₃,

H₂N(C₆H₄)C₃H₆Si(OCH₃)₃,

BrC₃H₆Si(OCH₃)₃,

H₂NC₂H₄NHC₂H₄(C₆H₄)C₃H₆Si(OCH₃)₃ and

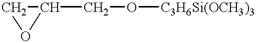

Another aspect of the present invention is to provide coated surfaces coated in prepared products, which are difficult or impossible to wet with polar liquids.

The coating of surfaces using chlorosilanes is known in the industrial sector of the hydrophilicization or improvement of sliding friction capability of surfaces. For example, EP 0 599 150 discloses a process in which a substrate is first treated with chlorosilanes. The chlorosilanes are adsorbed and then hydrolyzed. Another layer, e.g. a layer of a saccharide, polyether or polyvinylamine, can be chemically bonded to this layer. The process is applied in particular to a glass substrate, whereby the chlorosilanes bond to the substrate via functional groups. If substrates without functional groups are coated, activation of the substrate, e.g. with UV radiation, is necessary prior to the coating.

A similar process is described in U.S. Pat. No. 5,736,251 in order to improve the sliding friction capability of polymers. The polymers are treated, if desired after an additional activation process, with crosslinkable silanes and then cured in the presence of water and a catalyst if desired. This procedure forms a thick crosslinked siloxane layer which, under certain conditions, also has isolated elevations. The resulting modified sliding friction capability of the polymers depends on the type and length of the substituents of the silane. Substituents having more than 10 carbon atoms are less effective than short-chain substituents.

Another method of hydrophobicizing surfaces is disclosed in EP 0 492 545. Here, polymeric substrates are coated with a monomolecular layer of fluorine-containing organosilanes. EP 0 482 613 teaches a similar process, in which a polysiloxane layer is first created on a substrate by reaction of the substrate with chlorosilyl compounds. The polysiloxane layer is then reacted with a fluorocarbon siloxane derivative to give a fluorinated hydrophobic layer on the substrate. No structuring of the resultant surface is mentioned. Moreover, a further drawback is that fluorocarbon siloxanes are complicated to prepare and are expensive.

Surfaces coated by the technique of the invention have particularly high contact angles. The surface coatings of the invention substantially prevent the wetting of surfaces and give rapid droplet formation. With appropriate inclination of the surface, the droplets on the elevations can roll off and, as they do, pick up dirt particles and at the same time clean the surface.

The surfaces of the present invention are not only hydrophobic but also oleophobic. This property means that the surfaces coated in the manner of the present invention can also be applied in sectors where the presence of oil containing liquids or pollutants is to be expected, for example in road traffic, rail traffic and air traffic, and also in industrial production plants.

Articles with surfaces coated by the technique of the invention are very easy to clean. If there is not sufficient cleaning by droplets of, for example, rain water, dew or other water present in the area where the article is used, the articles can be cleaned simply by rinsing with water.

Bacteria and other microorganisms require water for adhesion to a surface or to multiply on a surface, and this condition is not available on the hydrophobic surfaces of the present invention. Surfaces structured by the method of the invention, therefore, prevent the growth of bacteria and other microorganisms and are, therefore, bacteriophobic and/or antimicrobial.

The wettability of surfaces can be measured via their surface energy. This variable can be determined, for example, by measuring the contact angle of various liquids on the smooth material (D. K. Owens, R. C. Wendt, J. Appl. Polym. Sci. 13, 1741 (1969)) and given in mN/m (millinewtons per meter). As determined by Owens et al., smooth polytetrafluoroethylene surfaces have a surface energy of 17.1 mN/m and the contact angle with water is 110°. Hydrophobic materials generally have contact angles with water of more than 90°. Depending on the hydrophobic compound used, materials coated according to the invention have contact angles of from 105-135°.

The method of the present invention has decisive advantages over conventional processes:

The silane derivatives which are used form isolated droplets on the substrate surface, and not a continuous film. These droplets may have a diameter of about 0.1-30 μm, and have a narrow distribution and are bonded firmly, in some cases covalently, to the substrate surface. The average droplet diameter can be adjusted by varying the coating parameters. On the surface of the droplets there are functional groups (Y in formula I) of the silane derivative used, and the functional groups are accessible there for further chemical reaction. If these groups are then reacted with a monomeric or polymeric hydrophobic compound, the result is chemical or physical bonding of this compound to the substrate via the silane derivative.

The formation of the droplets brings about microstructuring of the substrate surface and, associated with this, macroscopic surface hydrophobicization. However, sufficient untreated locations remain on the surface to ensure that there is no significant alteration to the physiological or mechanical properties of the polymer substrate.

The application of the silane derivative to the substrate surface preferably takes place in solution, in which case the solvent can also act as an additional swelling agent. Solutions in the range from 0.1-5.0% by volume of silane derivative, with hexane preferred as solvent, have proven successful in practice. However, other solvents which swell the substrate, for example, tetrahydrofuran, cyclohexane or toluene, can also be used in the present process.

The substrate to be treated is immersed in a solution of the silane derivative for about 1 s to 10 min or until swelling of the substrate is complete, preferably from 1-150 s at room temperature, followed by drying.

No particular temperature has to be maintained during the drying process. Room temperature, i.e., 20-25° C., is sufficient in most cases. However, temperature control in the range of 0-40° C., depending on the vapor pressure of the solvent, is advantageous during drying. The drying process can be conducted under a gas blanket or else in air, and a dustfree atmosphere is advisable.

In certain cases in which only desired areas are to be treated, partial immersion is also possible. Alternatively, the silane derivative may be applied by spraying or brushing rather than by immersion.

However, the silane derivative may also be deposited from the gas phase onto the substrate surface, without using solvent. Longer reaction or swelling times have to be adhered to in these cases, and there is no need for the drying step here.

After the polymeric substrate has been reacted with the silane derivative of formula I, the resultant layer of droplets can be hydrolyzed. The hydrolysis may take place during or after drying. Hydrolysis expediently takes place during drying in air, since the water content of the air generally facilitates a substantial degree of hydrolysis. Another method is to conduct a gentle steam treatment of the coated substrate after drying. The hydrolysis should be as complete as possible. Since the present process also allows coating of polymeric substrates which already have hydrophobic character, incomplete hydrolysis is possible. Hydrolysis times of 4 hours in air have proven successful in practice. For steam treatment the likely treatment time is about 2 hours. After hydrolysis of the coated substrates, drying can be conducted at a temperature of 40-150° C., preferably from 70-130° C.

After the substrate has been reacted with the silane derivative, hydrolyzed and then, if desired, dried at elevated temperature, it is treated with the hydrophobic compound.

Hydrophobic compounds which can be used in the present process include those which form ionic, adsorptive and/or covalent bonds with the silane derivative after it has reacted with the polymeric substrate and, either directly or after an additional chemical reaction, ensure adequate water-repellency.

Compounds which have proven successful contain a functional group such as a carboxylate group, by which the bond to the silane derivative is developed. In addition to a functional group the hydrophobic compound may contain at least one hydrophobic alkyl or phenyl group which optionally is partially or completely fluorinated. Suitable examples of hydrophobic compounds for use in the present process include perfluoroalkylsulfonyl halides, 1,2-epoxy-3-perfluoroalkyl propanes, perfluoroalkyl alcohols, perfluoroalkyl halides, bromo- and chloroperfluoroalkyl acetyl esters, alkyl halides, benzyl halides, perfluoroalkanecarboxylic acids, alkanecarboxylic acids and esters and anhydrides thereof, and mixtures of these compounds.

Other hydrophobic compounds include fluorine-containing polymers and copolymers such as perfluoroalkylethyl (meth)acrylate copolymers as disclosed in EP 0698 047. The fluorine-containing polymers and copolymers advantageously contain functional groups such as carboxylate, anhydride or epoxy groups.

The hydrophobic compounds may be applied in solution with an organic solvent. The treatment times range from 1-60 min and temperatures range from 20-90° C.

After the silane derivative and the hydrophobic compounds react with the polymeric substrate, the treated substrate can be dried at a temperature from 20-150° C., preferably from 50-130° C., particularly preferably from 80-120° C. In some cases the drying may be followed by a chemical reaction, e.g. esterification to improve hydrophobic properties.

During the reaction of the hydrophobic compound with the substrate which has previously been coated, or else during the drying operation which follows, this compound bonds to the polymeric substrate via the silane derivative. The bonding may be chemical or purely physical bonding.

The present process may be used to coat any polymeric substrate which is compatible with the silane derivative or its solution. Polymeric substrates which may be used include, in particular, polysiloxanes such as polydimethylsiloxane, polyurethanes, polyamides, polyesters, polyethylene, polypropylene, polystyrene, polyvinyl chloride, synthetic or natural rubber, polycarbonate and polymethyl methacrylate. The substrates coated may be in the form of pellets, semifinished products or finished products. In the case of pellets or semifinished products the mechanical properties of the coating should be considered when further processing is undertaken. If finished products are coated, selected parts of the product may be coated by controlled immersion, spraying, brushing or vapor deposition.

Surfaces coated by the processing of the invention may be transparent and are suitable for producing or coating headlamps, windscreens, surfaces of advertising material and solar cell covers (photovoltaic or thermal). Surfaces coated in the invention are, therefore, highly suitable for producing products which must be impossible or difficult to wet with polar liquids. Polar liquids include, in particular, water such as rainwater or process water from industrial production operations, waste water and liquids from medical-biological sectors such as brine and blood.

Surfaces coated in the present process may be used for producing films and other transparent covers, and also containers, holders, pipes, tubing and Petri dishes.

Other products which can be coated partially or completely by the present process include textiles, furniture and machinery, pipes and tubing, plastic sheathed cables, floor coverings, wall and ceiling surfaces, storage containers, packaging, window frames, signs, roofs, facade paneling, covers, awnings, traffic signs, signposts and medicotechnical items.

Examples of medical items include drains, cannulas, stems, vascular prostheses, dental prostheses, suture materials, bandaging or dressing materials, nonwovens, surgical instruments, medical tubing and catheters.

Having now generally described the invention, a further understanding can be obtained by reference to certain specific examples which are provided herein for purpose of illustration only and are not intended to be limiting unless otherwise specified.

### Preparation of the Coating Solution

### Coating Solution 1

N-(2-aminoethyl)-3-aminopropyltrimethoxysilane is mixed in various concentrations with anhydrous n-hexane in air at room temperature. The resultant solution can be used only for a short time, since hydrolysis and crosslinking of the silane, detectable by clouding, begins to occur after about 30 min, which is caused by moisture in the air.

### Coating Solution 2

N-(2-aminoethyl)-3-aminopropyltrimethoxysilane is mixed in various concentrations with anhydrous n-hexane under a blanket of argon at room temperature. The resultant solution remains usable for a relatively long time.

### Coating Solution 3

N-(2-aminoethyl)-3-aminopropyltrimethoxysilane is mixed in various concentrations with anhydrous cyclohexane under a blanket of argon at room temperature. The resultant solution remains usable for a relatively long time.

### Coating Solution 4

3-Aminopropyltriethoxysilane is mixed in various concentrations with anhydrous n-hexane under a blanket of argon at room temperature. The resultant solution remains usable for a relatively long time.

### Coating Solution 5

3-Trimethoxysilylpropyldiethylenetriamine is mixed in various concentrations with anhydrous n-hexane under a blanket of argon at room temperature. The resultant solution remains usable for a relatively long time.

### Example 1

### Coating of Polysiloxane Films

Perthese® polysiloxane films (Laboratoire Perouse Implant, France) were thoroughly cleaned with water and with isopropanol and dried at room temperature. The films pretreated in this way were immersed for 10 s in a 1.0% by volume Coating Solution 2. The films were dried at room temperature in air to constant weight then 1 h at 110° C.

After the first coating the film is immersed for 20 min in a 2.5% strength solution of CF₃(CF₂)₇CO₂H in isopropanol, dried at room temperature and then again for 1 h at 110° C. The coated films are extracted in isopropanol at room temperature for about 4 h. The finished coated films are strongly hydrophobic and permit water to run off in the form of droplets.

### Example 2

### Coating of Polyethylene Films

Polyethylene films were thoroughly cleaned with water and with isopropanol and dried at room temperature. The films pretreated in this way were immersed for 20 s in a 1.0% by volume Coating Solution 2. The films were dried at room temperature in air to constant weight then 1 h at 100° C.

After the first coating, the film is immersed for 20 min in a 2.5% strength solution of CF₃(CF₂)₇CO₂H in isopropanol, dried at room temperature and then further for 1 h at 110° C. The coated films are extracted in isopropanol at room temperature for about 4 h. The finished coated films are strongly hydrophobic and permiy water to run off in the form of droplets.

### Example 3

### Coating of Polysiloxane Films

Perthese® polysiloxane films (Laboratoire Perouse Implant, France) were thoroughly cleaned with water and with isopropanol and dried at room temperature. The films pretreated in this way were immersed for 10 s in a 1.0% by volume coating solution prepared as in Version 2. Drying is at room temperature in air to constant weight, then 1 h at 110° C.

After the first coating the film is immersed for 30 min in a 2.5% strength solution of 1,2-epoxy-3-(perfluorononyl)propane in isopropanol at 40° C., dried at room temperature and then again for 1 h at 110° C. The coated films are extracted in isopropanol at room temperature for about 4 h. The finished coated films are strongly hydrophobic, with a contact angle of 130°, and permit water to run off in the form of droplets.

### Example 4

### Coating of Polysiloxane Films

Perthese® polysiloxane films (Laboratoire Perouse Implant, France) were thoroughly cleaned with water and with isopropanol and dried at room temperature. The films pretreated in this way were immersed for 10 s in a 1.0% by volume Coating Solution 2. Drying is at room temperature in air to constant weight, then 1 h at 110° C.

After the first coating, the film is immersed for 30 min in a 2.5% strength solution of perfluorooctylsulfonyl chloride in CCl₄, dried at room temperature and then again for 1 h at 110° C. The coated films are extracted in isopropanol at room temperature for about 4 h. The finished coated films are strongly hydrophobic and permit water to run off in the form of droplets.

### Example 5

### Variation of Droplet Diameter

Perthese( polysiloxane films (Laboratoire Perouse Implant, France) were thoroughly cleaned with water and with isopropanol and dried at room temperature. Individual films pretreated in this way were each immersed for 10 s in coating solutions of 5.0, 2.0, 1.25, 1.0 and 0.5% strength by volume prepared from Coating Solution 2. Drying is at room temperature in air to constant weight, then 1 h at 110° C.

Films coated in this way were studied with a scanning electron microscope (Phillips, SEM 515). Before the images were taken, the specimens were sputtered with gold/palladium. Magnification in each case was 500:1.

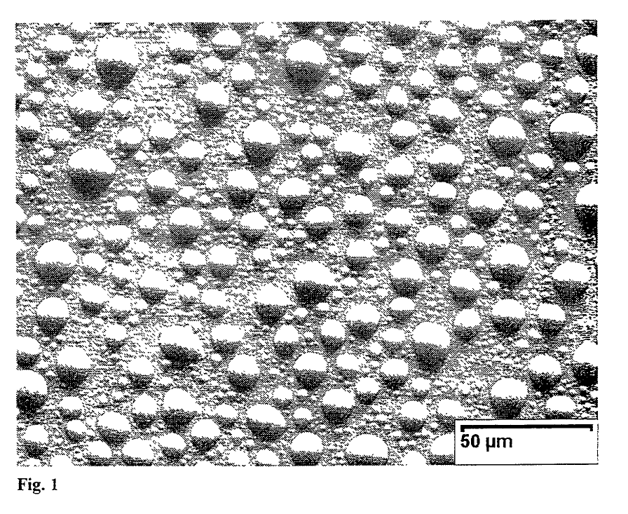

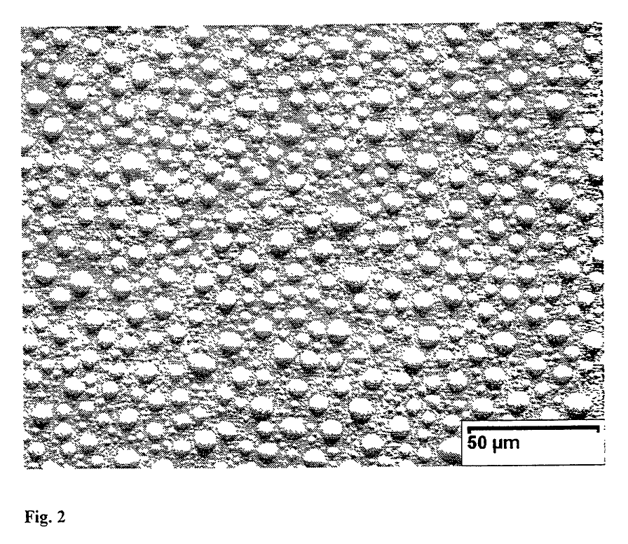

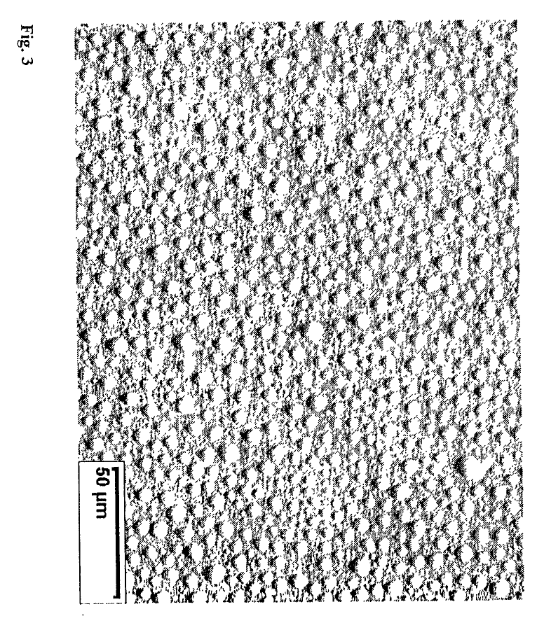

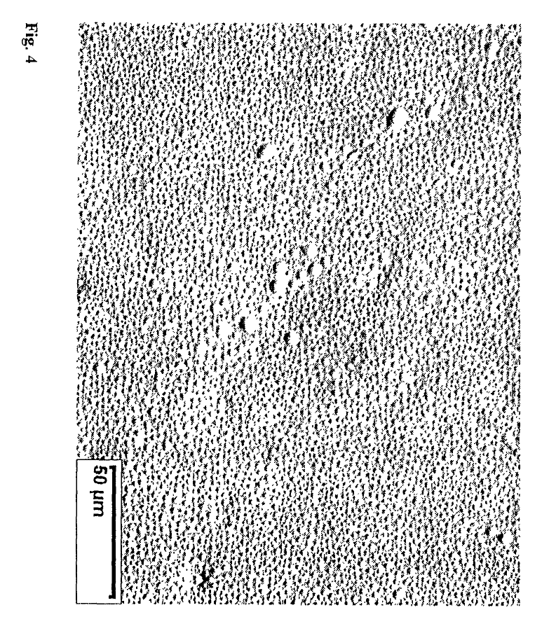

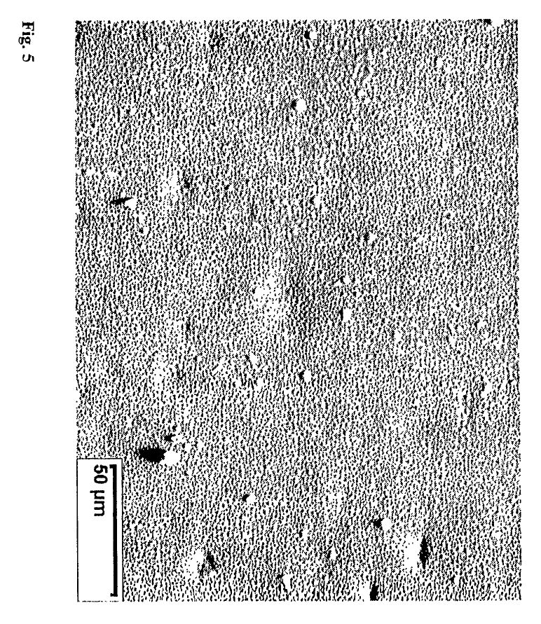

FIGS. 1-5 show the dependence of droplet size, and thus the elevations, on silane concentration.

TABLE 1

| Silane concentration | Average |
|---|---|
| [% by volume] | droplet diameter [μm] |
| 5.0 | 10-20 |
| 2.5 | 7-10 |
| 1.25 | 3-5 |
| 1.0 | 1-2 |
| 0.5 | 0.7-1.1 |

The disclosure of German priority Application Number 19900494.3 filed Jan. 8, 1999 is hereby incorporated by reference into the present application.

Obviously, numerous modifications and variations of the present invention are possible in light of the above teachings. It is, therefore, to be understood that within the scope of the appended claims, the invention may be practiced otherwise than as specifically described herein.

What is claimed as new and is intended to be secured by Letters Patent is:

1. A process for producing long-term-hydrophobic coatings on polymeric substrates, which comprises:
reacting the polymeric substrates initially with a silane derivative of formula I
[Y(R¹Z)ₘR²]ₙSiR³ₚX₄₋ₙ₋ₚ (I)
where p=0 to 2, n=0 to (3−p), and m=0 to 5; R^{1, R}², R³=a C₁-C₁₂-alkyl radical, a C₂-C₁₂-alkylene radical, a phenyl radical or a phenylalkyl radical, wherein R² and R³ in each case are identical or nonidentical to R¹;
Y═HS—, H₂N—, HR¹N—, R¹₂N—, —Cl, —Br, —I, —CN, R¹S—, 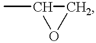
—SO₂Cl, OCN—, —CO₂R¹ or —SCN,
Z═—S—, —O—, R¹N— or —HN—, X═F—, Cl—, Br—, R⁴O—, HO—, H— or —NR₂¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby imparting structure to the surfaces of the polymeric substrates; and then
reacting the treated surfaces with a hydrophobic compound.

2. The process as claimed in claim 1, wherein the hydrophobic compound has a functional group and at least one hydrophobic alkyl or phenyl group.

3. The process as claimed in claim 2, wherein the at least one hydrophobic alkyl or phenyl group is at least partially fluorinated.

4. The process as claimed in claim 1, wherein the hydrophobic compound is a perfluoroalkylsulfonyl halide, a 1,2-epoxy-3-perfluoroalkylpropane, a perfluoroalkyl alcohol, a perfluoroalkyl halide, a bromo- or chloroperfluoroalkyl acetyl ester, an alkyl halide, a benzyl halide, a perfluoroalkanecarboxylic acid, an alkanecarboxylic acid or an ester or anhydride thereof, or a mixture of these compounds.

5. The process as claimed in claim 1, wherein the hydrophobic compound is a fluorine-containing polymer or copolymer.

6. The process as claimed in claim 1, wherein, after reacting the polymeric substrate with the silane derivative of formula I, the resultant structured surface is hydrolyzed.

7. The process as claimed in claim 1, wherein, after reacting the polymeric substrate with the silane derivative of formula I and with a hydrophobic compound, the substrate is dried at a temperature from 20-150° C.

8. The process as claimed in claim 1, wherein the substrate is treated with the silane compound in a solution at a concentration of 0.1-5.0% by volume.

9. The process as claimed in claim 1, wherein the hydrophobic compound is applied in an organic solvent onto a surface for 1-60 min and temperatures from 20-90° C.

10. The process as claimed in claim 1, wherein the polymeric substrate is a polysiloxane, polydimethylsiloxane, polyethylene, polyamide, polyurethane, polyester, polypropylene, polystyrene, polyvinyl chloride, synthetic or natural rubber, polycarbonate or polymethyl methacrylate.

11. The process as claimed in claim 1, wherein the silane compound is
H₂NC₃H₆Si(OCH₃)₃,
H₂NC₂H₄NHC₃H₆Si(OCH₃)₃,
HSC₃H₆Si(OCH₃)₃,
H₂NC₂H₄NHC₂H₄NHC₃H₆Si(OCH₃)₃,
(CH₃)₂NC₃H₆Si(OCH₃)₃,
H₂N(C₆H₄)C₃H₆Si(OCH₃)₃,
BrC₃H₆Si(OCH₃)₃,
H₂NC₂H₄NHC₂H₄(C₆H₄)C₃H₆Si(OCH₃)₃ or

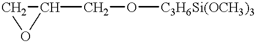

12. A process for producing products which are difficult or impossible to wet with polar liquids, comprising:
coating at least one surface of a substrate with a silane derivative of formula I
[Y(R¹Z)ₘR²]ₙSiR³ₚX₄₋ₙ₋ₚ (I)
where p=0 to 2, n=0 to (3−p), and m=0 to 5; R¹, R², R³=a C₁-C₁₂-alkyl radical, C₂-C₁₂-alkylene radical, a phenyl radical or a phenylalkyl radical, wherein R² and R³ in each case are identical or nonidentical to R¹;
Y═HS—, H₂N—, HR¹N—, R¹₂N—, —Cl, —Br, —I, —CN, R¹S—, 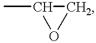
—SO₂Cl, OCN—, —CO₂R¹ or —SCN,
Z═—S—, —O—, R¹N— or —HN—, X═F—, Cl—, Br—, R⁴O—, HO—, H— or —NR₂¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby imparting structure to the surfaces of the polymeric substrates; and then
reacting the treated surface with a hydrophobic compound.

13. A method of producing films or transparent covers, comprising: coating at least one surface of a substrate with a silane derivative of formula I
[Y(R¹Z)ₘR²]ₙSiR³ₚX₄₋ₙ₋ₚ (I)
where p=0 to 2, n=0 to (3−p), and m=0 to 5; R¹, R², R³=a C₁-C₁₂-alkyl radical, a C₂-C₁₂-alkylene radical, a phenyl radical or a phenylalkyl radical, wherein R² and R³ in each case are identical or nonidentical to R¹;
Y═HS—, H₂N—, HR¹N—, R¹₂N—, —Cl, —Br, —I, —CN, R¹S—, 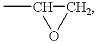
—SO₂Cl, OCN—, —CO₂R¹ or —SCN,
Z═—S—, —O—, R¹N— or —HN—, X═F—, Cl—, Br—, R⁴O—, HO—, H— or —NR₂¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby imparting structure to the surfaces of the polymeric substrates; and then
reacting the treated surface with a hydrophobic compound, thereby preparing said film or transparent cover.

14. A method of producing containers, holders, pipes or tubes, comprising:
coating at least one surface of a substrate of a designated shape with a silane derivative of formula I
[Y(R¹Z)ₘR²]ₙSiR³ₚX₄₋ₙ₋ₚ (I)
where p=0 to 2, n=0 to (3−p), and m=0 to 5; R¹, R², R³=a C₁-C₁₂-alkyl radical, a C₂-C₁₂-alkylene radical, a phenyl radical or a phenylalkyl radical, wherein R² and R³ in each case are identical or nonidentical to R¹;
Y═HS—, H₂N—, HR¹N—, R¹₂N—, —Cl, —Br, —I, —CN, R¹S—, 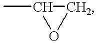
—SO₂Cl, OCN—, —CO₂R¹ or —SCN,
Z═—S—, —O—, R¹N— or —HN—, X═F—, Cl—, Br—, R⁴O—, HO—, H— or —NR₂ ¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, thereby imparting structure to the surfaces of the polymeric substrates; and then
reacting the treated surface with a hydrophobic compound, thereby preparing said containers, holders, pipes or tubes.

15. A substrate provided with a hydrophobic coating, comprising:
a polymeric substrate having at least one surface structured with silane derivative of formula I:
[Y(R¹Z)ₘR²]ₙSiR³ₚX₄₋ₙ₋ₚ (I)
where p=0 to 2, n=0 to (3−p), and m=0 to 5; R¹, R², R³=a C₁-C₁₂-alkyl radical, a C₂-C₁₂-alkylene radical, a phenyl radical or a phenylalkyl radical, wherein R² and R³ in each case are identical or nonidentical to R¹;
Y═HS—, H₂N—, HR¹N—, R¹₂N—, —Cl, —Br, —I, —CN, R¹S—, 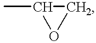
—SO₂Cl, OCN—, —CO₂R¹ or —SCN,
Z═—S—, —O—, R¹N— or —HN—, X═F—, Cl—, Br—, R⁴O—, HO—, H— or —NR₂¹, wherein R⁴ is a C₁-C₆-alkyl radical, a C₂-C₈-alkoxy radical, a C₅-C₇-cycloaliphatic radical, —C(O)R¹, —Si(CH₃)₃, a phenyl radical or a phenylalkyl radical, said structured surface hydrophobized with a hydrophobic compound.
